(19) United States
(12) Patent Application Publication
(10) Pub. No.: US 2008/0021354 A1
(43) Pub. Date: Jan. 24, 2008

(54) Device for increasing focus through alternating stimulations

(76) Inventor: David Abel Ostrov, Highland Park, IL (US)

Correspondence Address: DAVID A. OSTROV, 1857 CLOVERDALE AVE., HIGHLAND PARK, IL, 60035, US

(21) Appl. No.: 11/487,870

(22) Filed: Jul. 17, 2006

(51) Int. Cl. A61H 1/00

(52) U.S. Cl. 601/70; 601/71; 601/79

(57) ABSTRACT

A device for increasing focus by inducing alternating tactile stimulations in a person is disclosed. The device aids a persons ability to think clearly while reading, writing and thinking. The device includes a master vibrating element and a slave vibrating element. The person places the master vibrating element in his left pocket and the slave vibrating device in his right pocket. When the device is activated the following occurs in sequence: the master vibrating element vibrates, pauses, the slave vibrating element vibrates, pauses, the master vibrating element vibrates, pauses, the slave vibrating element vibrates, pauses, and so forth, until the device is deactivated. The master and slave vibrating elements are preferably of a hand-held size and shape. The controller has several operating features including: (a) a vibration-duration control which regulates and controls the duration, and thereby intensity, of vibrations (typically 30 to 3000 milliseconds), and (b) a pause-duration control which regulates and controls the length of the pause between vibrations (typically 30 to 4000 milliseconds).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This device allows people to better focus on the task at hand. It alternatively stimulates the left hemispheres of the brain. The left hemisphere is linear, logical, practical, and time orientated. The right hemisphere is much more non-linear, abstract, creative, holistic, and non-logical. The device keeps the two sides together and in rhythm.

This device extends the work of Schmidt and other pioneers in the field of EMDR. These people developed devices that stimulate the left and right hemisphere of the brain. EMDR is a therapeutic technical that aids people in recovering from psychological issues.

Some of these devices use a bouncing LED light display to stimulate the left and right hemisphere. Others use tactile stimulation. These devices are remarkably simple. They simple alternatively stimulate the left and right hemisphere of the brain through audio, light and/or tactile stimulation. In all cases these devices are only used during EMDR therapy.

Our invention is to extend a similarly simple device for general use. We have determined that the alternating left hemisphere, right hemisphere stimulation allow for increased focus for any person. It can be used while working, studying, listening or any other moment that requires increased focus and attention.

We've made the device small and unobtrusive. The master and slave element fit easily into a left pocket and right pocket. They vibrate alternatively. A person is free to type on a computer, write, read, listen, work on a problem, fix something, work in a factory, etc. . . . .

The hands, eyes, ears and mind are free to work on the task at hand, whatever that task may be.

2. Prior Art

In EMDR the two vibrating elements are used as a psychotherapeutic device to aid the EMDR therapist. We have extended their use to generalized focusing while studying, working, reading and generalized thinking.

This reapplication of an existing technology is innovative and novel.

### BACKGROUND OF INVENTION—OBJECTS AND ADVANTAGES

Alternating vibrations from left to right and back to left, stimulate the left and right hemisphere of the brain. This stimulation keeps a person on task and focused. The human brain has a left hemisphere and a right hemisphere. The left hemisphere is linear, logical, practical, and time orientated. The right hemisphere are much more non-linear, abstract, creative, holistic, and non-logical. This device keep the two sides together and in rhythm. It is believed that this functional map is consistent for an estimated 70 to 95 percent of people.

Our brain, like the rest of our anatomy, is made up of two halves, a left brain and a right brain. Consider that Nobel Prize Winner (1981) Roger Sperry conducted what are sometimes called the “split-brain” experiments”. Here's what happened: A patient suffering from uncontrolled seizures had an area of his brain removed by surgery in an attempt to control his illness. This area just was the corpus collosum and was suspected of having developed lesions (short circuits). Following his surgery, Sperry's patient seemed completely normal. However, a series of tests were conducted where each “half” of the patient's brain was isolated from the other. Different visual and tactile information could then be presented to the patient's left or right side, without the other side knowing.

With their communications link severed, each side of the patient's brain was functioning independently. Although this did not prevent his ability to walk, talk and eat, some unexpected findings were encountered in some of the higher brain functions when each side was examined independently of the other.

The right hand and eye could name an object, such as a pencil, but the patient could not explain what it was used for. When shown to the left hand and eye, the patient could explain and demonstrate its use, but could not name it. Further studies showed that various functions of thought are physically separated and localized to a specific area on either the left or right side of the human brain.

The point here is that there are two modes of thinking. The right brain understands important ideas; like that a wooden stick with graphite is used for writing, while the left brain thinks about what to write and what to name a pencil.

We all tend to use different parts of our brain in our own individual way. Accountants, engineers and software developers are highly trained in their left brain. They are good at the managing the details: at organizing and remembering the minutiae. Marketers, designers and artists are more in touch with their intuition and are guided by a bigger picture. They will often ignore the details and operate without structure. Neither mode of operating is superior, just different.

This device helps a person to fully comprehend the details and still be able to think at a forty thousand foot level. It helps them to see the big picture and be more productive. By stimulating the left and right side of your body this device brings the left and right brain together.

The vibrations serve as a constant reminder. The vibrations keep a person going the right direction. Whether a person is reading, writing, working, studying or any other activity that requires focus, the left and right sides of your brain are engaged.

### SUMMARY

The present invention offers a simple and easy way for inducing alternating tactile stimulations in a person. The device includes a master vibrating element and a slave vibrating element. The elements are placed in a person pockets. When the device is activated the following occurs in sequence: the first vibrating element vibrates, pauses, the second vibrating element vibrates, pauses, the first vibrating element vibrates, pauses, the second vibrating element vibrates, pauses, and so forth, until the device is deactivated. The master element has several operating features including: (a) a vibration-duration control which regulates and controls the duration of vibrations (typically 30 to 3000 milliseconds), and (b) a pause-duration control which regulates and controls the length of the pause between vibrations (typically 30 to 4000 milliseconds).

### DRAWING—FIGURES

FIG. 1 shows the device inducing alternating tactile stimulations in a subject.

FIG. 2 shows close-up perspective of the master vibrating element and the slave vibrating element.

FIG. 3 shows a cutaway of the master vibrating element and the slave vibrating element.

FIG. 4 shows the operation of the device by way of an electrical block diagram.

### DRAWINGS—REFERENCE NUMERALS

| | |
|---|---|
| 12 | subject |
| 20 | master vibrating element |
| 21 | first electric motor |
| 22 | wire |
| 23 | circuit board |
| 25 | battery housing |
| 27 | radio frequency transmitter |
| 30 | slave vibrating element |
| 31 | second electric motor |
| 32 | wire |
| 33 | circuit board |
| 35 | battery housing |
| 38 | antenna |
| 40 | vibration-duration control |
| 50 | pause-duration control |
| 60 | on/off button |
| 100 | micro-controller |
| 200 | micro-controller |

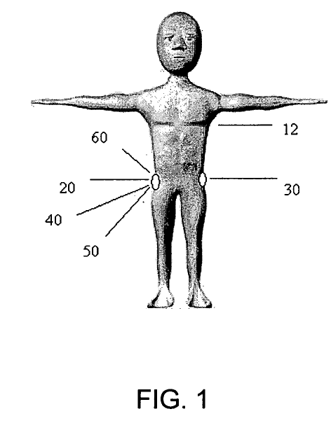

FIG. 1 shows the device inducing alternating tactile stimulations in a subject 12 who is has a master vibrating element 20 in his right pocket and a slave vibrating element 30 in his left pocket. The master vibrating element has an on and off button 60, a vibration-duration control 40, a pause-duration control 50.

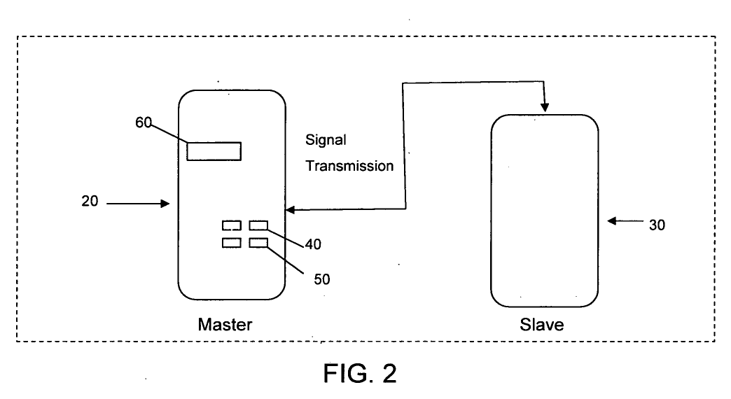

FIG. 2 shows close-up perspective of the master vibrating element 20 and the slave vibrating element 30. The master vibrating element and the slave vibrating element are connected through frequency signal (radio, infrared, ultrasonic). The master vibrating element contains an on and off switch 60, a vibration-duration control 40 that can be increased or decreased, a pause-duration control 50 that can be increased or decreased.

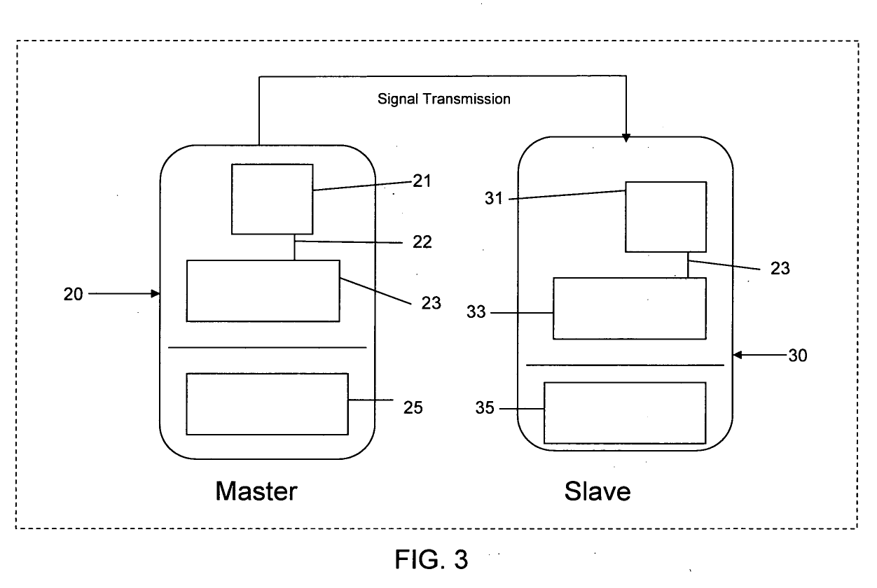

FIG. 3 shows a cutaway of the master vibrating element 20 and the slave vibrating element 30. Both elements are both made of plastic or metal, preferably rounded in shape and of a size to be easily placed in a person's left and right pockets. Firmly attached within the master vibrating element 20 is a master electric motor 21. Firmly attached within the slave vibrating element is a slave electric motor. The master electric motor 21 is connected with a wire 22 to the circuit board 23. The circuit board 23 contains a transmitter 27. The slave electric motor 31 is connected with a wire 23 to the circuit board 33. The circuit board 33 contains a receiver. The master vibrating element 20 contains a battery housing 25. The slave vibrating element 30 contains a battery housing 35.

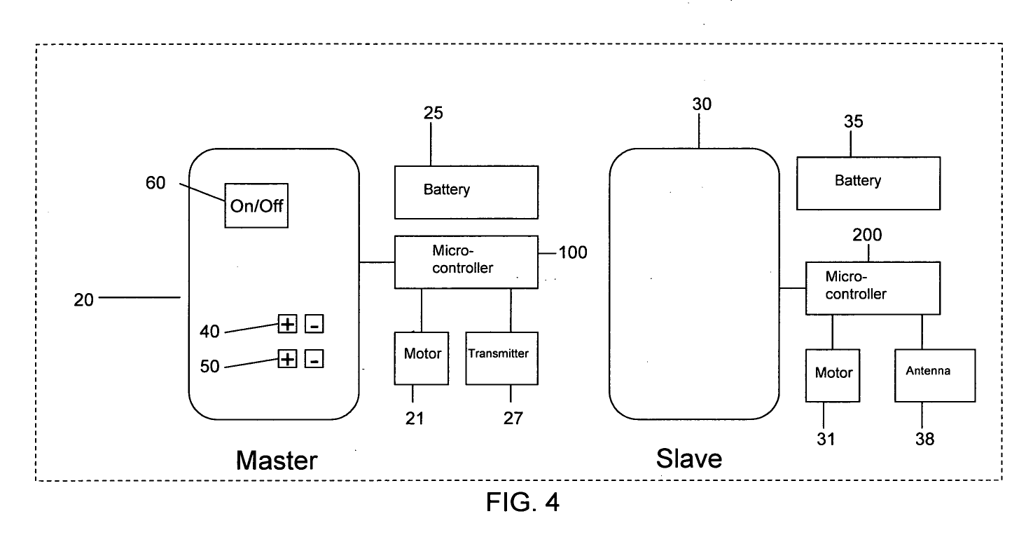

Referring now to FIGS. 1 and 4, the subject 12 can be seen placed in contact with the master and slave vibrating elements 20 and 30 (FIG. 1), for example, by place one in each pocket. Other forms of bodily contact are also acceptable as long as they occur on opposite sides of the body, for example, against each thigh or against each forearm.

FIG. 4 illustrates the operation of the invention by way of an electrical block diagram. When the power switch 60 is closed, power travels to the programmable micro-controller 100 for the master unit. The micro-controller 100 sends a wake signal to the slave unit. This awakens the slave unit and the slave unit goes to wait mode. The micro-controller 100 then sends a signal to start the vibration in the first unit vibrating motor 21. The vibrating motor will run for the set duration and stop. The micro-controller 100 then determines the duration of the vibration and pause between vibrations. The micro-controller 100 pauses for the pause duration and then transmits a signal to slave unit's micro-controller 200 to vibrate for a set duration. The antenna 37 in the slave unit will receive the signal. The slave unit's micro-computer 200 will send signal to slave unit vibrating motor 31 to run for specific duration that was sent to it by the master transmitter. The master unit and slave units will work in an alternating fashion and the respective vibrating motors will run for the set duration after the set interval. The activation of the master vibrating motor 21, followed by a pause, and the activation of the slave vibrating motor 31, followed by a pause, constitutes an “activation cycle.” Every time the power switch 60 is turned on the system resets to the previous setting. By operating the vibration-duration control 40 the user can increase or decrease the duration of the vibrations during an activation cycle, with the duration ranging from 30 to 3000 milliseconds. And by operating the vibration-interval control 50 the user can increase or decrease the interval of the vibrations during an activation cycle, with the interval ranging from 30 to 4000 milliseconds This essentially controls the intensity as well as the interval of the tactile stimulation which is simply a function of how long the first and second vibrating motors 21 and 31 are activated. By operating the pause-duration control 50, the operator can increase or decrease the amount of time between the end of one vibration and the start of the next, with the pause length ranging from about 30 to 4000 milliseconds. This essentially controls the cycling frequency, since shorter pauses means more rapid cycling than longer pauses. Table 1 defines an exemplary control logic sequence programmed into the programmable micro-controller 100, Table 2 defines the exemplary control logic programmed into the programmable micro-controller 200.

TABLE 1

Start:

Turn on master unit
Transmit signal to activate slave unit
Cycle:
Read Resistance Value of Vibration-duration
Control and store in Vibration.sub.-- Value
Read Resistance Value of Pause-duration
Control and store in Pause.sub.-- Value
Activate Master Motor for Vibration.sub.-- Value X milliseconds
Pause for Pause.sub.-- Value X milliseconds
Transmit signal to slave unit to vibrate along with
Value of Vibration-duration Control --
Value
Goto Cycle

TABLE 2

Start:
Turn on slave unit after receiving transmission from master unit
Cycle:
Read signal from master unit
Read Resistance Value of Vibration-duration Control
and store in Vibration.sub.-- Value
Activate slave Motor for Vibration.sub.-- Value X milliseconds
Goto Cycle

While the foregoing embodiments are at present considered to be preferred, it is understood that numerous variations and modifications may be made therein by those skilled in the art. For example, the size and shape of the master and slave units may be altered to conform to the contours of the hands or other parts of a subject's body. In the case of their use by children, the vibrating elements may be embedded in an appealing toy or stuffed animal. In addition, fastening straps may be used to attach the vibrating elements to the subject's limbs or torso. There are alternatives to electric motors with off-center weights for inducing vibrations. Some of these include, but are not limited to, electromagnetic vibrators, and acoustic elements (such as speakers operated at set frequencies). Other embodiments for the controller might consist of various combinations of keypads and visual displays such as membrane switches, joysticks, dials, meters, liquid crystal displays, and computer interfaces. Additionally, the activation of the vibrating elements may be accomplished by mechanisms other than electrical wires, such as a remote control mechanism employing radio, infrared, or ultrasonic communication. Thus the scope of the invention should be determined by the appended claims and their equivalents, rather than by the examples given.

1-15. (canceled)

16. A device for increasing focus as defined in claim 7 wherein the signal activating said master and slave signal-activated vibrating elements is an ultrasonic signal.

17. A device for increasing focus as defined in claim 7 wherein said activation period is manually adjustable.

18. A device for increasing focus as defined in claim 7 wherein said pause period is manually adjustable.
